(19) United States
(12) Patent Application Publication
(10) Pub. No.: US 2020/0311818 A1
(43) Pub. Date: Oct. 1, 2020

(54) MITIGATING MALICIOUS USE OF PUBLIC DATA FOR TRADING PORTFOLIOS

(71) Applicant: ETF Global Technologies, LLC, Bainbridge Island, WA (US)

(72) Inventors: Todd MILLER, Ladera Ranch, CA (US); Larry Snyder, Bainbridge Island, WA (US)

(21) Appl. No.: 16/838,929

(22) Filed: Apr. 2, 2020

Related U.S. Application Data
(63) Continuation-in-part of application No. 16/366,928, filed on Mar. 27, 2019.

(51) Int. Cl. G06Q 40/06; G06Q 40/04; G06Q 20/38; H04L 9/06

(52) U.S. Cl. CPC G06Q 40/06; G06Q 40/04; G06Q 20/3823; H04L 2209/38; G06Q 2220/00; H04L 2209/16; H04L 9/0643

(57) ABSTRACT

Embodiments provide systems, methods, and computer-readable storage media for concealing a makeup of a portfolio of traded assets via an optimized holdings file distributed to the public. In embodiments, a holdings file is received that identifies an actual makeup of a portfolio and an obfuscation engine is executed against the holdings file to produce an optimized holdings file. The optimized holding file approximates the portfolio over time but does not include information that reflects the actual makeup of the portfolio at any particular instance in time. The optimized holdings file may be publicly distributed to users while the holdings file is encrypted and distributed to authorized participant servers only, where the encrypted holdings file is ingested by a trading engine of the authorized participant server for use in market making operations with respect to the traded assets held in the portfolio of traded assets.

### CROSS REFERENCE TO RELATED APPLICATIONS

This application is a continuation-in-part of U.S. patent application Ser. No. 16/366,928, filed Mar. 27, 2019, and entitled “SYSTEMS AND METHODS FOR BLOCKCHAIN-BASED TRADING OF PORTFOLIOS” (Attorney Docket No. ETFP.P0001US), the disclosure of which is incorporated by reference herein in its entirety.

### TECHNICAL FIELD

The present disclosure relates generally to trading systems and more specifically to a system architecture that mitigates malicious use of public data regarding a portfolio of traded assets.

### BACKGROUND

Technology-based trading systems have become widespread and enable various market participants (e.g., individuals, institutional investors, etc.) to buy and sell traded assets such as stocks, bonds, exchange traded funds (ETFs), mutual funds, and the like. While these trading systems have provided significant advantages to the market participants in the form of convenience, speed of execution, and accessibility, modern technology-based trading systems still suffer from several drawbacks. To illustrate, the Securities and Exchange Commission (SEC) has imposed regulations that govern various aspects of how traded assets are purchased, sold, etc. Some general examples of regulation by the SEC include restrictions on insider trading and imposing disclosure requirements on certain entities associated with traded assets. Due to the widespread availability of publicly available trading systems, some traded assets may be negatively impacted by the regulations imposed by the SEC. For example, portfolios of traded assets (e.g., ETFs) may be structured or configured to a specific goal, such as tracking the performance an index (e.g., the S&P 500), and managing entities for these portfolios of traded assets may be required to publicly disclose the traded assets held in the portfolio. Such public disclosure may enable third party market participants (e.g., traders that are not associated with the portfolio of traded assets) to implement actions (e.g., front-running and/or free-riding) that could negatively impact the portfolio and its performance (e.g., increasing costs, etc.). Thus, the widespread availability of trading systems coupled with disclosure requirements mandated by government regulations may have a negative impact on various types of traded assets, such as portfolios of traded assets and ETFs in particular.

### SUMMARY

In the disclosed embodiments, systems, methods and computer-readable storage media providing increased data security and transparency with respect to a portfolio of traded assets are disclosed. In the disclosed embodiments, a primary authorized participant server may be configured to maintain holdings data related to the quantities of traded assets held in the portfolio and other information in an encrypted format on a blockchain that is accessible to authorized users (e.g., regulatory authorities, liquidity providers facilitating operations to maintain the portfolio, third party auditors, and the like). The primary authorized participant server may be configured to periodically retrieve a copy of the holdings from the blockchain and distribute the holdings file to one or more primary authorized participant servers that are configured to initiate various operations configured to align the portfolio with its designated goals, such as to ensure that the net asset value of the portfolio is equivalent to the net asset value of the underlying assets held in the portfolio. The primary authorized participant server may include one or more rules engines that are configured for execution against the holdings file received from the primary authorized participant server to determine which operations are to be performed in order to align the portfolio with the relevant goals. Such operations may include purchasing quantities of the underlying traded assets and exchanging the quantities of traded assets for additional shares of the portfolio that can be sold via a marketplace, which may be a trading platform facilitating the purchase of traded assets (including purchases of the shares of the portfolio). The operations may also include purchasing a quantity of shares of the portfolio from a marketplace and redeeming the shares of the portfolio for an equivalent value of traded assets held in the portfolio, which may be subsequently sold by the primary authorized participant server via the marketplace. The operations performed by the primary authorized participant server may be designed to impose upwards or downwards pressure on the shares of the portfolio and/or the underlying traded assets in order to drive the values towards equilibrium (e.g., so that the value of the shares of the portfolio accurately reflects the value of the underlying traded assets held in the portfolio).

To prevent third party marketplace participants from significantly impacting the performance of the portfolio, the holdings data written to the blockchain may be encrypted so that only authorized users (e.g., the primary authorized participant servers or other select entities) can access the data of the holdings file, which discloses the underlying traded assets and the quantities of each of the underlying traded assets held in the portfolio. This may prevent front-running, where a third party marketplace participant is able to predict future trade operations to be performed by the primary authorized participant servers and then execute those trades prior to their execution by the primary authorized participants. Additionally, this may mitigate free-riding, where a third party market participant copies the actions of the primary authorization servers, which may be especially pertinent to actively managed portfolios of traded assets.

The immutable records of the blockchain may further enable robust auditing to be performed to verify the performance and integrity of the portfolio. For example, the blocks of the blockchain may provide a historical record of the quantities of each traded asset held in the portfolio, as well as changes to those quantities over time. Auditing operations may be performed using this information in conjunction with historical marketplace data related to the underlying traded assets to, amongst other things, verify whether the operations executed by the primary authorization servers actually align the portfolio with its configured goals (e.g., tracking an index or some other desired property of the portfolio).

The disclosed systems, methods, and computer-readable storage media also provide operations for concealing a makeup of a portfolio of traded assets via an optimized holdings file designed for public distribution. An obfuscation engine is provided and includes a set of rules configured to conceal or mask the actual makeup of the portfolio of traded assets. When the holdings file is received (e.g., by a primary AP server or by an obfuscation server), the obfuscation engine may be executed against the holdings file to produce an optimized holdings file. The optimized holding file approximates the portfolio over time but does not include information that reflects the actual makeup of the portfolio at any particular instance in time. The optimized holdings file may be publicly distributed to users while the holdings file is encrypted and distributed to authorized participant servers only, where the encrypted holdings file is ingested by a trading engine of the authorized participant server for use in market making operations with respect to the traded assets held in the portfolio of traded assets.

The foregoing has outlined rather broadly the features and technical advantages of the present invention in order that the detailed description that follows may be better understood. Additional features and advantages will be described hereinafter which form the subject of the claims. It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims. The novel features which are believed to be characteristic of embodiments described herein, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present embodiments.

### BRIEF DESCRIPTION OF THE DRAWINGS

For a more complete understanding, reference is now made to the following descriptions taken in conjunction with the accompanying drawings, in which:

FIG. 1 is a block diagram of a system facilitating secure and transparent trading of a portfolio of traded assets in accordance with embodiments;

FIG. 2 is a block diagram illustrating an exemplary processing flow for executing a creation operation in accordance with embodiments;

FIG. 3 is a block diagram illustrating an exemplary processing flow for executing a redemption operation in accordance with embodiments;

FIG. 4 is a flow diagram of an exemplary method for blockchain-based management of a portfolio of traded assets in accordance with embodiments;

FIG. 5 is a block diagram of an embodiment of a system facilitating secure and transparent distribution of information corresponding to a portfolio of traded assets in accordance with embodiments of the present disclosure; and

FIG. 6 is a flow diagram of an exemplary method for concealing the makeup of a portfolio of traded assets according to embodiments of the present disclosure.

### DETAILED DESCRIPTION

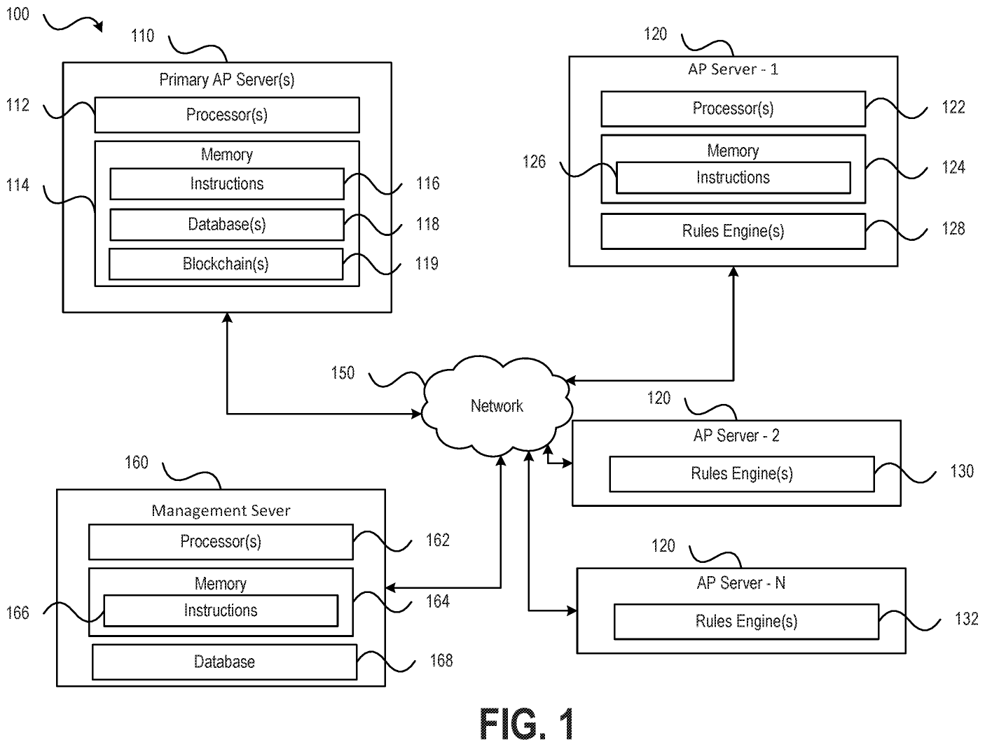

Referring to FIG. 1, a block diagram of a system facilitating secure and transparent trading of a portfolio of traded assets in accordance with embodiments is shown as a system 100. As shown in FIG. 1, the system includes a primary authorized participant server 110, a plurality of authorized participant servers 120, one or more marketplace servers 140, and a management server 160. A network 150 may communicatively couple each these servers to facilitate various operations of the system 100, as described in more detail below.

The primary authorized participant server 110 may include one or more processors 112 and a memory 114. Each of the one or more processors 112 may be a central processing unit (CPU) having one or more processing cores. The memory 114 may include read only memory (ROM) devices, random access memory (RAM) devices, one or more hard disk drives (HDDs), one or more flash memory devices, one or more solid state drives (SSDs), one or more network attached storage (NAS) devices, other devices configured to store data in a persistent or non-persistent state, or a combination of different memory devices. The memory 114 may store instructions 116 that, when executed by the one or more processors 112, cause the one or more processors 112 to perform operations described in connection with the primary authorized participant server 110 with reference to FIGS. 1-5. Additionally, the memory 114 may be utilized to provide one or more databases 118 and a blockchain 119. Exemplary aspects of the one or more databases 118 and the blockchain 119 are described in more detail below.

As shown in FIG. 1, the plurality of authorized participant servers 120 includes a first authorized participant server (PAP Server-1), a second authorized participant server (PAP Server-2), and an Nth authorized participant server (PAP Server-N). It is noted that although FIG. 1 illustrates the system 100 as including three authorized participant servers 120, embodiments of the present disclosure may include more than three authorized participant servers 120 or less than three authorized participant servers. Additionally, it is noted that while portfolios of traded assets typically utilize two or more authorized participants, the system 100 may be configured to include a single authorized participant server if desired.

As illustrated in FIG. 1 with respect to the first authorized participant server (PAP Server-1), each of the authorized participant servers 120 may include one or more processors 122, a memory 124, and one or more rules engines (e.g., rules engines 128, 130, 132). Each of the one or more processors 122 may be a CPU having one or more processing cores. The memory 124 may include ROM devices, RAM devices, one or more HDDs, one or more flash memory devices, one or more SSDs, one or more NAS devices, other devices configured to store data in a persistent or non-persistent state, or a combination of different memory devices. The memory 124 may store instructions 126 that, when executed by the one or more processors 122, cause the one or more processors 122 to perform operations described in connection with the authorized participant server 120 with reference to FIGS. 1-5. As described in more detail below, each of the one or more rules engines may be configured for execution against an input data set to derive one or more actions to be performed with respect to a portfolio of traded assets and one or more modifications to the portfolio of traded assets may be realized as a result of the actions. For example, the first authorized participant server includes one or more rules engines 128, the second authorized participant server (PAP Server-2) includes one or more rules engines 130, and the Nth authorized participant server (PAP Server-N) includes one or more rules engines 132. It is noted that although FIG. 1 illustrates each of the three authorized participant servers as including one or more rules engines (e.g., rules engines 128, 130, 132), systems configured in accordance with embodiments may include authorized participant servers that include different numbers of rules engines. For example, some authorized participant servers may include one rules engine, while other authorized participant servers may include more than one rules engine. Additional details regarding operation of the authorized participant servers 120 and the one or more rules engines are described below.

The one or more marketplace servers 140 may include one or more processors 142 and a memory 144. Each of the one or more processors 142 may be a CPU having one or more processing cores. The memory 144 may include ROM devices, RAM devices, one or more HDDs, one or more flash memory devices, one or more SSDs, one or more NAS devices, other devices configured to store data in a persistent or non-persistent state, or a combination of different memory devices. The memory 144 may store instructions 146 that, when executed by the one or more processors 142, cause the one or more processors 142 to perform operations described in connection with the one or more marketplace servers 140 with reference to FIGS. 1-5. The one or more marketplace servers 140 may facilitate trading activities with respect to various traded assets, including shares of portfolios of traded assets. For example, the one or more marketplace servers 140 may provide one or more marketplaces (e.g., web-based marketplaces or other trading platforms) that enable members of the public or institutional investors to purchase stocks, shares of portfolio traded assets (e.g., ETFs, mutual funds, etc.), and other traded assets.

The management server 160 may include one or more processors 162 and a memory 164. Each of the one or more processors 162 may be a CPU having one or more processing cores. The memory 164 may include ROM devices, RAM devices, one or more HDDs, one or more flash memory devices, one or more SSDs, one or more NAS devices, other devices configured to store data in a persistent or non-persistent state, or a combination of different memory devices. The memory 164 may store instructions 166 that, when executed by the one or more processors 162, cause the one or more processors 162 to perform operations described in connection with the management server 160 with reference to FIGS. 1-5. As described below, the management server 160 may be operated by an entity that issues a portfolio of traded assets and may be configured to issue shares of a portfolio of traded assets to one or more authorized participants (e.g., operators of the one or more authorized participant servers 120) in exchange for quantities of traded assets held in the portfolio or provide quantities of traded assets held in the portfolio of traded assets to one or more authorized participants (e.g., operators of the one or more authorized participant servers 120) in exchange for shares of the portfolio.

In embodiments, the management server 160 may be operated by an entity that issues portfolios of traded assets. As an example, suppose that an entity desires to issue a portfolio of traded assets, such as an exchange traded fund (ETF). The entity may structure the ETF to track a particular index, such as the S&P 500 index, or to have some other desired goal or metric of performance. To issue the portfolio of traded assets (e.g., the ETF), the issuer may work with one or more authorized participants (also referred to as liquidity providers), such as large financial institutions (e.g., banks), to obtain traded assets, such as stocks, corresponding to the particular index or other configured goal(s) of the portfolio. It is noted that where the particular index is composed of a particular ratio of traded assets, the authorized participants may purchase the traded assets in proportion to the particular ratio of traded assets associated with the particular index. Having acquired the traded assets, the authorized participants may provide the traded assets to the issuer in exchange for a quantity of shares of the portfolio of traded assets (e.g., shares of the ETF). Once the authorized participants receive the shares of the portfolio of traded assets, the authorized participants may sell the shares, such as by offering them for sale via the one or more marketplace servers 140.

As a result of the processes described above, the issuer of the portfolio of traded assets obtains holdings corresponding to the quantities of traded assets received from the authorized participants. Upon receiving the holdings, the issuing entity may create a traded holdings file that indicates the quantities of each of the traded assets held in the portfolio. In addition to recording the quantities of each of the traded assets, the traded holdings file may include additional information, such as one or more timestamps, a purchase price at which each of the traded assets was acquired, a rules engine utilized to effect the purchase of the traded assets (or a portion thereof), or other information. The timestamps may include date information (e.g., the date on which a particular quantity of a traded asset was acquired or received from a primary authorized participant), time information (e.g., the time at which the particular quantity of the traded assets was acquired or received from a primary authorized participant), or both date information and time information. It is noted that portions of the holdings may be acquired at different times, on different dates, and by different authorized participants. This may occur for a variety of reasons, such as through changes in the holdings corresponding to the portfolio over time, acquiring different portions of the holdings through different rules engines of different authorized participants, changes in the strategy or configuration of the portfolio goals, or for other reasons. For example, at the end of each day a traded holdings file reflecting all activity executed with respect to the portfolio of traded assets may be generated (e.g., a daily traded holdings file) and intraday traded holdings files may be generated periodically during each trading day as changes to the portfolio occur due to operations of system 100, such as changes made to the configuration of the portfolio (e.g., modifying a ratio of one or more traded assets held in the portfolio or modifying a makeup of the holdings of the portfolio).

The traded holdings file may also include information that identifies one or more exchanges (e.g., marketplace servers 140) utilized by the authorized participant servers 120 to effect the transactions (or outcomes) determined by the one or more rules engines. To illustrate, each of the one or more rules engines of the different authorized participant servers 120 may be configured to receive a holdings file, which may be generated based on trading activity from the previous day or based on intraday trading activity. As described in more detail below, the one or more rules engines may be configured to execute a set of rules against a received holdings file to determine one or more operations, such as creation, redemption, and arbitrage operations, to be initiated to manage aspects of the portfolio of traded assets in accordance with the configured goals of the portfolio and may utilize the one or more exchanges facilitated by the one or more marketplace servers 140 to execute the one or more operations. It is noted that portions of the operations resulting from the execution of the one or more rules engines may be performed at different exchanges depending on market conditions. For example, if certain trading operations would be more advantageous (e.g., from a cost perspective, a trade execution time perspective, a market demand perspective-demand for a traded asset may be greater at one exchange than another, enabling the trade to be completed swiftly due to the higher demand, or other factors) at a first exchange while other trades would be more advantageous at a second exchange, portions of the trading operations that would be more advantageous at the first exchange may be performed via the first exchange while other trade operations may be performed via the second exchange. Thus, multiple exchanges may be utilized to execute trading activities associated with the actions determined by the one or more rules engines based on the holdings file. Including information regarding the particular exchange utilized for a particular transaction may increase the transparency of the operations of the system 100 and enhance the quality of information provided during audits of the system 100. It is noted that trade information may indicate or associate particular transactions with particular exchanges, as well as rules engines, such as to associate at least a portion of a transaction with a specific rules engine of the one or more rules engines. It is noted that marketplace servers utilized to facilitate operations of the system 100 may include dark pools and that the indication of the particular marketplace server, whether a dark pool or not, may be indicated in the holdings file.

As trading data is received from the authorized participant servers 120, it may be compiled into a traded holdings file and stored in the database 168 associated with the management server 160. The traded holdings file may additionally be provided to the primary authorized participant server 110, which may write the holdings file or information associated with the holdings file to the blockchain 119. In an aspect, the holdings file written to the blockchain 119 may be different from the holdings file stored in the database 168. For example, the blockchain 119 may facilitate third party access, such as by the authorized participant servers 120, to the information of the holdings file written to the blockchain. As such, the holdings file written to a block of the blockchain 119 may include less information than may be included in the holdings file stored in the database 168. For example, one or more pieces of information (e.g., information regarding the particular rules engine utilized to acquire a particular portion of the traded assets held in the portfolio) included in the traded holdings file stored in the database 168 may be redacted prior to providing the holdings file to the primary authorized participant server 110 and writing the holdings file to the blockchain 119. As an example, the holdings file received by the primary authorized participant server 110 may include information that identifies the traded assets held in the portfolio and information associated with the makeup or configuration of the portfolio.

The information that identifies the traded assets held in the portfolio may include a list of ticker symbols, a list of Committee on Uniform Securities Identification Procedures (CUSIP) identifiers, or other information that may identify the traded assets held in the portfolio and the information that identifies the makeup or configuration of the portfolio may include a percentage associated with each traded asset (e.g., what percentage of the portfolio is made up of the corresponding traded asset). For example, if a portfolio includes 3 traded assets (e.g., asset-1, asset-2, and asset-3), the holdings file received by the primary authorized participant server 110 and written to the blockchain 119 may include identifiers for each of the 3 traded assets (e.g., an identifier “ABC” may correspond asset-1, an identifier “DEF” may correspond to asset-2, and an identifier “EFG” may correspond to asset-3) as well as information that identifies the makeup or configuration of the portfolio (e.g., asset-represents 40% of the portfolio, asset-2 represents 35% of the portfolio, and asset-3 represents 25% of the portfolio). It is noted that the particular manner of indicating the makeup or configuration of the portfolio may be achieved in a variety of ways and is not limited to percentages. For example, the information may be indicated by specifying the total quantity of traded assets held in the portfolio and the quantities of each individual traded asset held in the portfolio, by indicating only the quantities of each traded asset held in the portfolio, as percentages (as described above), other types of information, or combinations of these types of information. It is noted that redacting information from the holdings file that may be irrelevant to the third parties accessing the holdings file via the blockchain 119 may reduce the likelihood that the use of the holdings file by third parties is tainted or influenced by the irrelevant information.

The database 118 of the primary authorized participant server 110 may include information that identifies particular authorized participant server(s) 120 that are authorized to receive holdings file information stored at the blockchain 119. In an aspect, the holdings file may be encrypted prior to being written to the blockchain 119. Encryption of the holdings file may be performed using an advanced encryption standard (AES) 256 bit cipher or another encryption technique depending on the particular configuration of the system 100. It is noted that the particular block of the blockchain 119 to which the holdings file is written may include information that identifies a first or previous block of the blockchain. Accordingly, as changes to the holdings file are made over time, such as due to changes in the makeup of the traded assets of the portfolio (e.g., changes to the quantities of traded assets, changes to the traded assets included in the portfolio, etc.), each iteration of the holdings of the portfolio are recorded to a new block of the blockchain 119 and each block of the blockchain 119 links to a previous block of the blockchain 119 corresponding to a previous iteration of the holdings of the portfolio. Further, it is noted that each block of the blockchain 119 may be timestamped with information (e.g., date information, time information, or both) corresponding to when the block was created. These immutable records (e.g., the blocks of the blockchain 119) may enable auditing of the portfolio, as described in more detail below.

In an aspect, rather than writing the holdings file to the portfolio of traded assets, the primary authorized participant server 110 may be configured to encrypt and store the holdings file (or the redacted version of the holdings file) to the database 118 and record a hash of the holdings file to the blockchain 119. In such an arrangement, distribution of the holdings files to the authorized participant servers 120 may be facilitated from the encrypted holdings files recorded at the database 118, rather than from the blockchain 119. By recording a hash of the holdings file on the blockchain 119, the authenticity of the holdings files stored in the database 118 and/or the database 168 may be determined. To illustrate, suppose that a holdings file is recorded to the database 118 and a hash of the holdings file is recorded on the blockchain 119. If the authenticity of the holdings file needs to be determined at a subsequent time, such as during an audit, the holdings file may be retrieved from the database 118 and hashed. The resulting hash value may be compared to the hash of the holdings file recorded to the blockchain 119 to establish the holdings file distributed to the authorized participant servers 120 was not altered (e.g., if the two hashes match the authenticity of the holdings file may be established and if the two hashes do not match the holdings file may be determined to have been altered prior to or subsequent to distribution to the authorized participant servers 120). Additionally, writing a hash to the blockchain may minimize the size of the blockchain 119 and facilitate more cost effective administration of the blockchain 119. It is noted that the blockchain 119 may be a public blockchain or a private blockchain. In an aspect, a hash of the holding file may be recorded in the database 118 and the encrypted holdings file may be recorded to the blockchain 119. Such an arrangement would facilitate authentication of the holdings file in a manner similar to the technique described above, except the hash value is recorded in the database 118 and the holdings file is stored on the blockchain 119, rather than the other way around in the example above.

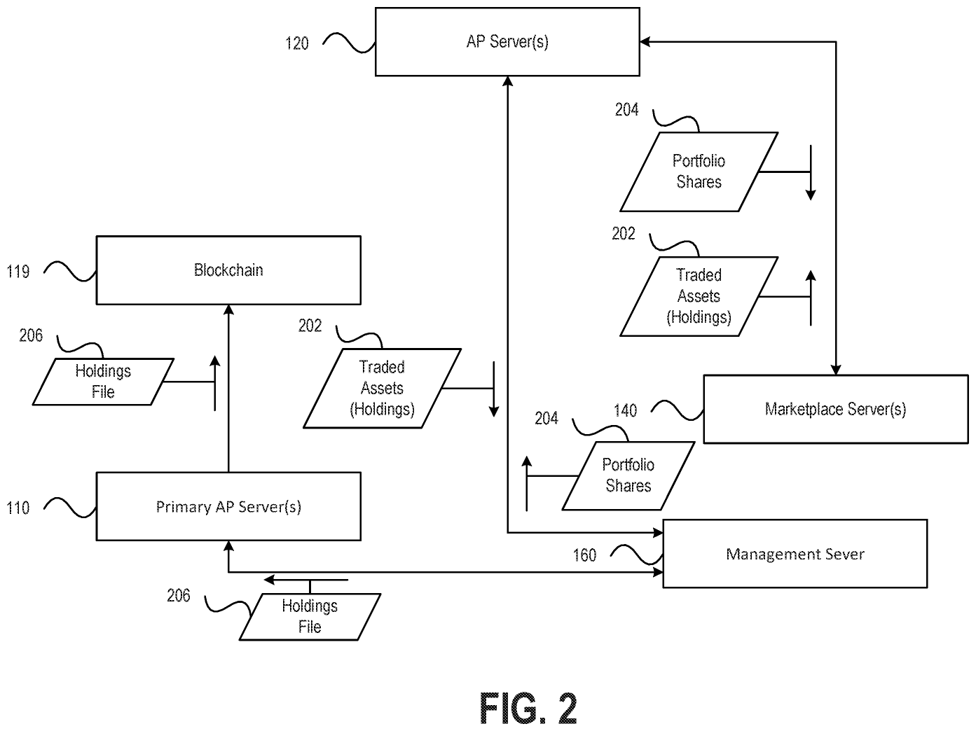

Referring briefly to FIG. 2, a block diagram illustrating an exemplary process for issuing a portfolio of traded assets in accordance with embodiments is shown. As shown in FIG. 2, during issuance of the portfolio of traded assets, quantities of one or more traded assets 202 are acquired by the authorized participant server(s) 120, such as by buying stocks or other traded assets via the one or more marketplace servers 140. The quantities of one or more traded assets 202 may be provided to the management server 160 and a quantity of portfolio shares 204 may be provided to the authorized participant server(s) 120. The quantity of portfolio shares 204 may then be sold by the authorized participant server(s) 120 via the marketplace server(s) 140. Upon receiving the quantities of one or more traded assets 202, the management server 160 may create a holdings file 206 (or update a previous holdings file) that identifies the quantities of the one or more assets 202, as described above. The holdings file 206 may be stored in the database 168 (not shown in FIG. 2) and may also be provided to the primary authorized participant server 110, which may write the holdings file 206 to the blockchain 119 (or store the holdings file 206 at the database 118 and write a hash of the holdings file 206 to the blockchain 119). As explained above with reference to FIG. 1, the holdings file may be encrypted prior to being written to the blockchain 119, the database 118, or both.

Referring back to FIG. 1, the makeup of the portfolio of assets and the outstanding quantity of shares of the portfolio may change over time due to operations initiated by the authorized participant servers 120. For example, the portfolio of traded assets may be configured by the issuing entity to track the performance of the underlying traded assets held in the portfolio. One of the roles of the authorized participant servers 120 may be to monitor the value of the portfolio (or the value of the portfolio shares) relative to the values of the underlying traded assets and to ensure that the value of the portfolio (or the portfolio shares) is in line with the net asset value (NAV) of the underlying shares. To facilitate this role, the authorized participant servers 120 may be configured to periodically receive the holdings file recorded on the blockchain 119 (or the database 118) from the primary authorized participant server 110 and execute the one or more rules engines against the holdings file (or portions thereof). For example, each of the rules engines may be configured to monitor all or a portion of the traded assets held in the portfolio and to initiate various operations to harmonize the NAV of the portfolio with the underlying assets. The operations initiated by the authorized participant server 120 may include creation and redemption operations.

In a creation operation, the authorized participant server 120 may purchase quantities of the underlying traded assets (e.g., as may be determined by execution of one or more rules engines against the holdings file) and provide the quantities of the underlying traded assets to the management server 160 in exchange for a quantity of shares of the portfolio. It is noted that creation operations may be performed based on specific unit sizes or blocks. For example, if the block or unit size is 50,000, a creation operation may result in the authorized participant server 120 purchasing quantities of traded assets having a value equal to the block or unit size (e.g., 50,000) of the portfolio shares. The quantities of traded assets may then be provided (e.g., as a creation unit) to the management server 160 in exchange for the block of shares of the portfolio. In this manner, the portfolio obtains traded assets needed to maintain its intended configuration (e.g., properly tracking the index or other target or goal specified for the portfolio) and the primary authorized participant obtains portfolio shares that may be sold (e.g., for a profit). As explained above, the creation operation may result in changes to the makeup of the portfolio, such as by increasing quantities of traded assets held in the portfolio. Accordingly, when creation operations are performed, the management server 160 may generate an updated holdings file, which may be stored at the database 168 and provided to the primary authorized participant server 110, which may write the holdings file (or a hash of the holdings file) to a new block on the blockchain 119. It is noted that the creation operation may be performed in a manner similar to the operations illustrated in FIG. 2.

One or more of the rules engines may initiate the creation process in response to a determination that the current market price of the portfolio shares exceeds the net asset value of the underlying trade assets held in the portfolio (e.g., the market price of the portfolio shares are “overpriced” or out of line with the net asset value of the underlying trade assets). Through the creation process, an authorized participant server 120 may initiate a purchase of additional quantities of the traded assets to form a creation unit, exchange the creation unit for a quantity of portfolio shares, and sell the obtained quantity of portfolio shares via the marketplace server(s) 140. Selling the quantity of portfolio shares obtained by the creation process may place downward pressure on the market price of the shares of the portfolio while buying the quantities of traded assets may place upward pressure on the value of the traded assets, thereby driving the price of the portfolio shares to a value that is more in line with the net asset value of the traded assets held in the portfolio.

In a redemption operation, an authorized participant server 120 may purchase a quantity of portfolio shares via the marketplace server(s) 140 and provide the quantity of portfolio shares to the management server 160 in exchange for quantities of the underlying traded assets held in the portfolio. It is noted that redemption operations may be performed based on specific unit sizes or blocks. For example, if the block or unit size is 50,000, a redemption operation may result in the authorized participant server 120 purchasing a redemption unit (e.g., 50,000 shares of the portfolio). The redemption unit of portfolio shares may then be provided from the authorized participant server 120 to the primary authorized participant server 110 in exchange for quantities of the underlying traded assets having an equivalent value with respect to the redemption unit. In this manner, the portfolio is maintained in its intended configuration (e.g., properly tracking the index or other target or goal specified for the portfolio) and the primary authorized participant obtains additional traded assets that may be sold (e.g., for a profit). For example, buying the quantity of portfolio shares may place upward pressure on the market price of the shares of the portfolio while selling the quantities of traded assets may place downward pressure on the value of the traded assets, thereby driving the price of the portfolio shares to a value that is more in line with the net asset value of the traded assets held in the portfolio.

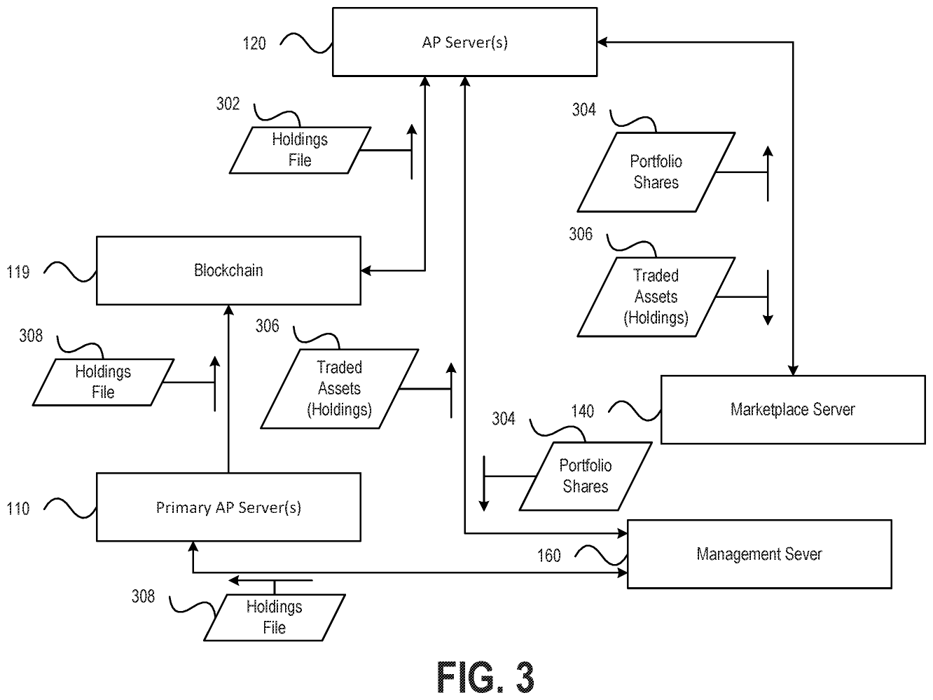

Referring briefly to FIG. 3, a block diagram illustrating an exemplary processing flow for a redemption operation is shown. In the exemplary redemption process shown in FIG. 3, the authorized participant server(s) 120 may obtain a holdings file 302 from the blockchain 119. As described above, the holdings file 302 may be encrypted and in such instances, the primary authorized participant may decrypt the holdings file 302 prior to executing the one or more rules engines against the holdings file 302. Alternatively, the holdings file 302 may be provided from the database 118, as described above. As a result of execution of the one or more rules engines against the holdings file 302, the authorized participant server(s) 120 may initiate a redemption operation. Upon a determination to initiate the redemption operation, the authorized participant server(s) 120 may purchase a quantity of portfolio shares 304 from the marketplace server(s) 140 and provide the quantity of portfolio shares 304 to the management server 160 and in return a quantity of traded assets 306 may be provided to the authorized participant server 120. As shown in FIG. 3, once received, the authorized participant server 120 may then sell the quantity of traded assets 306 via the marketplace server(s) 140. The management server 160, upon receiving the quantity of portfolio shares 304 from and providing the quantities of traded assets 306 to the authorized participant server 120 may generate an updated holdings file 308, which may be stored at the database 168 and provided to the primary authorized participant server 110. The primary authorized participant server 110 may write the holdings file 308 to a new block of the blockchain 119 or may write a hash of the holdings file 308 to the blockchain 119 and record the holdings file 308 at the database 118. As described above, the new block corresponding to the holdings file 308 may include a reference to a previously generated block, which may be the block from which the holdings file 302 was retrieved or a different block (e.g., if other modifications to the holdings file occurred before the redemption operation and were written to the blockchain 119 or for other reasons).

In an embodiment, the primary authorized participant server 110 may be configured to distribute the holdings file(s) to the one or more rules engines at particular times depending on whether the holdings file is based on a daily holdings file (e.g., a primary holdings file) or an intra-day holdings file. The daily holdings file may correspond to a holdings file generated following netting operations configured to settle all transactions executed with respect to the portfolio for a particular day. Stated another way, the daily or primary holdings file may represent a current status of the holdings of the portfolio at the beginning of a particular day. An intra-day holdings may be configured to reflect changes that occurred during a particular day and may be generated prior to the netting operations for the particular day. For example, following distribution of a holdings file generated based on the primary holdings file (i.e., a primary traded holdings file) to the one or more rules engines various transactions may be executed that result in changes to the holdings of the portfolio. At the end of the trading day, a new primary holdings file may be generated that reflects the trading activity performed by the authorized participants in response to distribution of the holdings file from the blockchain 119. In some instances, the issuer (e.g., the entity operating the management server 160) may alter the configuration or makeup of the portfolio and may provide an intraday holdings file to the primary authorized participant server 110. That holdings file may be written to the blockchain 119 (or both the blockchain 119 and the database 118), as described above, and then distributed to the authorized participant servers 120 to notify the authorized participants of the changes to the configuration of the portfolio. At the end of the trading day, the authorized participant servers 120 may communicate trading information that includes trading activity based on the holdings file distributed at the start of the trading day and may include trading activity based on the intraday holdings file distributed in response to modification of the makeup or configuration of the portfolio the management server 160. It is noted that creation and distribution of intra-day holdings files may vary from one day to the next. To illustrate, on some days one or more intra-day holdings files may be created and distributed by the system 100 and on other days no intra-day holdings files may be created.

In an aspect, distribution of holdings files (e.g., daily holdings files and intra-day holdings files) may be initiated via an application providing access to blocks of the blockchain 119. The distribution may be initiated prior to an opening of trading sessions at the one or more marketplace servers 140. For example, if trading via the one or more marketplace servers 140 opens at 9:00 AM Eastern Standard Time (EST), the holdings files may be distributed to the one or more rules engines prior to 9:00 AM EST. The primary authorized participant server 110 may be configured to initiate distribution of the holdings files based on a threshold distribution time, which may correspond to an amount of time prior to the opening of trading at the one or more marketplace servers 140. For example, the threshold distribution time may be configured to initiate distribution of the daily holdings file one hour prior to the opening of the one or more marketplace servers 140. It is noted that the threshold distribution time of one hour described above has been provided for purposes of illustration, rather than by way of limitation that the threshold distribution time may be configured to a period of time that is greater than one hour or less than one hour.

In an aspect, the time period associated with the threshold distribution time may be configured based on an expected amount of time required by the one or more rules engines to process the holdings file. For example, if the one or more rules engines require “X” amount of time to ingest the holdings file as an input and process the holdings file to determine whether any trading operations are to be performed, the threshold distribution time may be configured to be at least “X” amount of time so that each of the one or more rules engines may be ingest and process the holdings file by the time the one or more marketplace servers 140 open. Distribution of the holdings file(s) to the one or more rules engines may be synchronized such that the holdings file(s) is received by each of the one or more rules engines at the same or substantially the same time in accordance with the configuration of the threshold distribution time.

The primary authorized participant server 110 may be configured to receive information from each of the one or more rules engines prior to distribution of the holdings files. For example, the liquidity providers associated with the one or more rules engines may periodically make changes to the sets of rules utilized by the one or more rules engines to evaluate the holdings file in view of current market conditions. As each of the one or more rules engines is modified, information indicating a version of the holdings file may be provided to the primary authorized participant server 110. The version information may be recorded at the database 118 and timestamped to indicate the particular version of each of the one or more rules engines utilized for a particular day. Additionally, prior to authorizing a primary authorize participant server 120 to receive holdings file information from the primary authorized participant server 110, each of the primary authorized participants may provide the primary authorized participant server 110 with a certification that the rules engine(s) utilized by the authorized participant server 120 is configured to execute the set of rules against the holdings file in an automated manner and that human intervention cannot be utilized to override the trade operations initiated by the rules engine(s) based on the holdings file(s).

In an aspect, the primary authorized participant server 110 may be configured to provide an application programming interface (API) that interfaces the application to the blockchain 119 to ensure secure distribution of the holdings files. The API may be code scanned and security tested by the primary authorized participant server 110 to ensure the holdings file is not tampered with or altered during distribution to the one or more rule engines. The API may be configured to read the appropriate holdings file from the blockchain 119, decrypt the holdings file, and then provide the decrypted holdings file to each of the one or more rules engines as an input. Alternatively, the primary authorized participant server 110 may be configured to retrieve the hash of the holdings file (e.g., from the blockchain 119 or database 118) and compare the retrieved hash to a hash calculated based on the holdings file that is to be distributed to the authorized participant servers 120. If the two hashes match, the holdings file may be authorized for distribution to the authorized participant server 120.

The primary authorized participant server 110 may also provide a portfolio configuration API that may be utilized to modify the makeup the portfolio of traded assets. For example, the entity that controls (or created) the portfolio of traded assets may change one or more characteristics of the portfolio of traded assets over time, such as to change the ratios of the underlying traded assets of the portfolio, add one or more new traded assets to the portfolio, remove one or more traded assets to the portfolio. When a modification to the makeup of the portfolio is performed via the API, information may be transmitted to the authorized participant server 120 to notify the liquidity providers of the changes made with respect to the portfolio. The liquidity providers, and more specifically the one or more rules engines of the authorized participant server 120, may initiate one or more trade operations to implement the changes made to the makeup of the portfolio, such as to purchasing quantities of one or more traded assets (e.g., quantities of new traded assets added to the portfolio or quantities of traded assets having an increased weight (or percentage) within the portfolio, and the like), sell quantities of one or more traded assets of the portfolio (e.g., quantities of traded assets removed from the portfolio or quantities of traded assets having an decreased weight (or percentage) within the portfolio, and the like), or other operations. As these trading operations are executed, updated holdings file data may be generated by the management server 160 and provided to the primary authorized participant server 110, which may write the holdings file (or a hash of the holdings file) to the blockchain 119, as described herein. It is noted that the API may be accessed via one or more graphical user interfaces, such as a web-based application presented within a web page or a standalone application executing on a user device communicatively coupled to the primary authorized participant server 110 via a network. Additionally, access to the API and the associated user interfaces may require authentication (e.g., a username and password, two-factor authentication, etc.) of a user prior to enabling a modification of the portfolio to be made.

Referring back to FIG. 1, the redemption process may be initiated in response to identifying an arbitrage opportunity (i.e., the net asset value of the underlying traded assets is out of line with respect to the value of the shares of the portfolio). For example, at least one of the one or more rules engines may be configured to implement arbitrage operations designed to detect instances when the current market price of the portfolio shares is lower than the net asset value of the underlying trade assets held in the portfolio (e.g., the market price of the portfolio shares are “underpriced” or out of line with the net asset value of the underlying trade assets). The authorized participant server 120 may perform a redemption operation that may include purchasing of a quantity of shares of portfolio, exchanging the quantity of shares of portfolio for quantities of the underlying assets, and selling the quantities of the underlying assets via the marketplace server(s) 140. Selling the quantities of the underlying assets obtained by the redemption process places downward pressure on value of the underlying traded assets while purchasing the quantity of the portfolio shares may create upward pressure on value of the portfolio shares, thereby driving the price of the portfolio shares to a value that is more in line with the net asset value of the traded assets held in the portfolio (e.g., the market price of the portfolio shares increases and the market prices of one or more of the underlying traded assets decreases).

As another example, the arbitrage operations may be configured to detect when the net asset value of the underlying trade assets held in the portfolio is lower than the current market price of the portfolio shares (e.g., the net asset value of the underlying assets is “underpriced” or out of line with value of the shares of the portfolio). Upon identifying such a situation, the rules engine(s) may perform a redemption operation that may include purchasing quantities of the underlying traded assets, exchanging the quantities of the underlying assets for a quantity of shares of portfolio, and selling the quantity of shares of portfolio via the marketplace server(s) 140. Selling the quantity of shares of portfolio quantities obtained by the redemption process places downward pressure on value of the portfolio shares and purchasing the quantities of underlying assets creates upward pressure on value of the underlying assets, thereby driving the price of the portfolio shares to a value that is more in line with the net asset value of the traded assets held in the portfolio (e.g., the market price of the portfolio shares decreases and/or the market prices of one or more of the underlying traded assets increases).

As explained above, creation operations and redemption operations may result in changes to the makeup of the portfolio, such by decreasing or increasing the quantities of traded assets held in the portfolio. Accordingly, when such operations are performed, the management server 160 may generate an updated holdings file, which may be provided to the primary authorized participant server 110 and stored at the database 118 and/or written to a new block on the blockchain 119, as described above.

As described above, trading activities initiated based on outcomes generated by the one or more rules engines may be performed multiple times during a given day, which results in creation of intraday holdings files. As the intraday holdings files are created, the primary authorized participant server 110 may store the intraday holdings files to a database 118 and/or write the intraday holdings files to the blockchain 119. Once written to the blockchain 119, the primary authorized participant server 110 may generate one or more notification messages associated with the intraday holdings file(s). A notification message may indicate an address on the blockchain 119 to which a recently created (or most recent created) intraday holdings file was written. The notification message may be transmitted from the primary authorized participant server 110 to the authorized participant server 120 via the network 150 and once the notification message is received by the authorized participant server(s) 120 to signal the availability of an updated holdings file (e.g., the intraday holdings file).

The one or more authorized participant servers 120 may be configured to retrieve intraday holdings file by requesting the primary authorized participant server 110 to provide the contents of the block associated with the addresses of the blockchain 119 included in the notification message and may utilize the information included in the retrieved intraday holdings file to initiate further operations with respect to the portfolio of traded assets, such as to initiate additional trading activity based on changes in real-time market conditions. The trading activity initiated based on the intraday holdings files may be conducted in a manner similar to the operations described above with respect to FIGS. 2 and 3. The real-time market conditions may be determined based on information obtained from the one or more marketplace servers 140, which may be obtained by the authorized participant server 120 and/or by the one or more rules engines.

It is noted that rules established by the Securities and Exchange Commission (SEC) permit persons to trade in certain specified circumstances where it is clear that the information they are aware of is not a factor in the decision to trade, such as pursuant to a pre-existing plan, contract, or instruction that was made in good faith. The system 100 alleviates concerns regarding insider trading based on selective disclosure (i.e., distributing the holdings file) because the rules engines utilized by the primary authorized participant servers are configured to initiate trading activities in accordance with a pre-existing plan (e.g., the configuration of the rules utilized by the rules engine to initiate trading operations with respect to the shares of the portfolio and/or the underlying assets of the portfolio).

The system 100 may be configured to provide fully transparent auditing of activities related to the portfolio. For example, creation operations, redemption operations, and other trading activities related to the portfolio may be audited and verified using the database 118 and/or the blockchain 119. To facilitate auditing and verification, the primary authorized participant server 110 may be configured to receive an audit request from an interested party, such as the SEC or an independent third party. The audit request may be received via an a web-based application, such as a utility or feature provided via a website operated by the managing entity, via an e-mail message, or via an application programming interface providing access to at least one of the database 118 and/or the blockchain 119. The audit request may identify a particular time period to be audited, such as identifying a particular date (e.g., a day) or range of dates (e.g., days, weeks, months, years, etc.) to be addressed by the audit. In response to receiving the audit request, the primary authorized participant server 110 may generate audit data corresponding to the time period identified in the audit request. For example, the primary authorized participant server 110 may initiate a search process configured to identify blocks of the blockchain 119 or records within the database 118 that correspond to the relevant time period and may generate the audit data based on the information obtained by the search process. It is noted that the rules engines may be deterministic—that is, given a set of inputs, such as the makeup of the portfolio as identified by the holdings file and current market conditions, each of the rule engines may produce the same outcomes. Accordingly, during an audit, the audit data, which may include information representative of an instance of the holdings file at a particular point in time relevant to the audit, may be executed against the one or more rules engines to verify the operations performed with respect to the portfolio, such as to verify the one or more rules engines were operating in accordance with their programmed functionality and that the actions initiated by the one or more rules engines were made to benefit the portfolio, such as to align the portfolio with its intended configuration (e.g., tracking a particular index, etc.).

It is to be appreciated that such a recreation of prior activity initiated by the one or more rules engines may utilize historical pricing data associated with the shares of the portfolio as well as the underlying traded assets and as such the audit data may include timestamp information associated with the previous activity, information identifying particular rules engines utilized to initiate activity during the relevant time period (or a portion of the relevant time period) corresponding to the audit request, and the like. Further, it is noted that deriving or obtaining audit data from the blockchain 119 may provide a stronger sense of trustworthiness as compared to obtaining the audit data from the database 118. This is because the blocks of the blockchain 119 comprise immutable records that are not easily modified once added to the blockchain. It is also to be appreciated that audit processes may utilize both audit data derived from the blockchain 119 and the database 118, such as to verify the accuracy of the records stored in the database 118 or identify additional information included in the records of the database 118 that may have been redacted from the information recorded on the blockchain 119, such as information that identifies or associates specific rules engines with transactions resulting in changes to the holdings of the portfolio or information that specifies a version associated with a rules engine during a relevant time period. The accuracy of the records stored in the database 118 may be determined by executing the one or more rules engines in the manner described above using audit data derived from both database 118 and the blockchain 119 and then comparing the results to determine whether any discrepancies may exist. Additionally, by determining particular versions associated with the rules engines during a time period associated with an audit ensures that the recreation of the portfolio activity is not biased by any changes that may have been made to the rules engines subsequent to the time period associated with the audit.

In addition to facilitating audits by third parties, the system 100 may be configured to implement auditing operations, which may facilitate various different forms of oversight with respect to operations of the system 100. The auditing operations may be utilized by the primary authorized participant server 110 to monitor operations of the system 100 and identify anomalies with respect to activities performed utilizing the system 100, such as to identify suspicious trade activity, adverse price movement (e.g., price movement with respect to the shares of the portfolio and/or the underlying traded assets of the portfolio), prior price movements, and the like. For example, during auditing operations it may be discovered that after sending out a portfolio change a particular traded asset or a particular set of traded assets (e.g., one or more stocks held in the portfolio) experience price drops or increases with a discernable pattern. This may indicate potential information leakage with associated front running. In response to identifying the discernable pattern of price fluctuations, the system 100 may flag the activity as “suspicious activity” and an investigation may be initiated to confirm the presence of an information leakage and discover its source. Additionally, price movements associated with portfolio changes over a period of time may result in historical patterns. These historical patterns may be analyzed to determine whether an individual traded asset or group of traded assets exhibit suspicious volatility compared to historical norms. If these prior price movement anomalies are detected, that activity may be flagged by the system 100 and an investigation into the causes of the anomalous price movements may be initiated. It is noted that analysis of price movements and fluctuations may be performed using algorithmic analysis. Stated another way, the system 100 may be configured with pre-determined rules configured to analyze the activities associated with the portfolio to identify the presence of anomalies. By using algorithmic analysis, the results may be deterministic such that the same outcome is produced each time the analysis is performed on a given data set, thereby ensuring the repeatability of the results and ensuring trust in the auditing process. The auditing operations of the primary authorized participant server 110 may be utilized to monitor the performance of the portfolio and the activities associated with the one or more rules engines, which may enable the entity operating the primary authorized participant server 110 to identify underperforming liquidity providers (e.g., liquidity providers that are associated with rules engines that are negatively impacting the performance of the portfolio).

The management server 160 may be configured to perform netting operations. For example, at the end of each day for which the holdings of the portfolio have been modified, the management server 160 may determine net changes to the holdings of the portfolio and the shares of the portfolio based on the operations initiated by the one or more rules engines. Multiple modifications to the holdings and the shares of the portfolio may occur throughout a particular day as a result of the operations initiated by the one or more rules engines and fluctuating market conditions. The net changes may reflect the total (or net) change with respect to the holdings of the portfolio (e.g., to reflect the final quantities of traded assets held in the portfolio at the end of the particular day) and the shares of the portfolio (e.g., to reflect the number of issued shares of the portfolio taking into account any creations and redemptions that may have occurred). The net change information may be utilized to create a settlement record for the portfolio on the particular day, which may be reflected in the holdings file (e.g., a daily or primary holdings file) provided to the primary authorized participant server 110 at the end of a particular trading day.

Although in the description above the primary authorized participant serve 110 is illustrated and described as being separate from the management server 160 and the authorized participant servers 120, embodiments of the present invention are not to be limited to such configurations. For example, in an embodiment the operations of the primary authorized participant server 110 may be performed by management server 160 or may be performed by one of the authorized participant servers 120. It is to be appreciated that the operations of the system 100 described above provide a new approach to the operations associated with creating and managing portfolios of traded assets. For example, the infrastructure utilized to facilitate operations of the system 100, including the blockchain 119 and the primary authorized participant server 110, provides a new approach to providing workflows that support operations associated with portfolios of traded assets. As an example, the primary authorized participant server 110 provides a centralized point of access from which authorized participant servers 120 may receive the holdings files recorded on the blockchain 119, and distribution of the holdings files to the plurality of rules engines facilitates improved trading operations by the authorized participant servers 120. This centralized distribution architecture provides a computational environment that allows for trade engine order/execution, data capture, and post-trade diagnostics designed to ensure that holdings files are appropriately utilized for the benefit of the portfolio shareholders.

Post-trade diagnostics may facilitate various refinements to the operations of the system 100. For example, analytics may be utilized by liquidity providers to modify the rules sets associated with the one or more rules engines, such as to adjust risk tolerances, modify metrics utilized to identify arbitrage opportunities, and the like. Additionally, the authorized participant server 120 may utilize analytics facilitated by the information stored in the blockchain 119 to refine its operations, such as to adjust thresholds associated with adjusting aggregated quantities of shares corresponding to outcomes produced by the one or more rules engines. The analytics may additionally or alternatively be utilized by the authorized participant server 120 to configure priorities associated with one or more marketplace servers 140 (e.g., generate a ranked list of marketplaces) such that marketplace servers 140 that are more advantageous (e.g., faster trade execution times, reduced fees, and the like) are prioritized over less advantageous marketplace servers 140. It is noted that the exemplary analytics operations described above have been provided for purposes of illustration, rather than by way of limitation and that a system implementing the concepts disclosed herein may readily utilize analytics for other purposes as may be desired by the relevant systems, parties, and configuration of the system 100.

Additional benefits provided by the system 100 and the work flows that are supported by the system 100 may include: reduced operational costs and improved performance with respect to distribution of assets (e.g. holdings and/or shares of the portfolio), which may encourage more entities to issue portfolios of traded assets; increased activity for liquidity providers, which may provide increased opportunities to generate revenue/profits from arbitrage operations; reduced operational burdens; increases in the number of portfolios of traded assets available to investors (e.g., due to the decreased costs and other benefits provided by the system 100); true intraday liquidity; and mitigation of front loading and free running by third parties. It is noted that work flows and processes implemented by the various components of the system 100 result in an improved system that may be more efficiently utilized to manage portfolios of traded assets. For example, while many of the operations performed by the system 100 may be similar to operations performed by previous systems, such previous systems operated in isolation from one another and were not capable of realizing the advantages provided by the centralized nature of the system 100, in which multiple rules engines may be operated in coordination with one another to support the portfolio of traded assets. Additionally, it is noted that such improvements are not realized simply by utilizing a computer to perform the operations described herein-instead, the system 100 provides a centralized architecture that facilitates new processes that interact with one another in a coordinated manner to realize the aforementioned processing efficiencies and advantages, such as enabling aggregation of trading activity from multiple rules engines, recording trading activity within immutable records of the blockchain, enabling coordinated and synchronized distribution of holdings files, and the like.

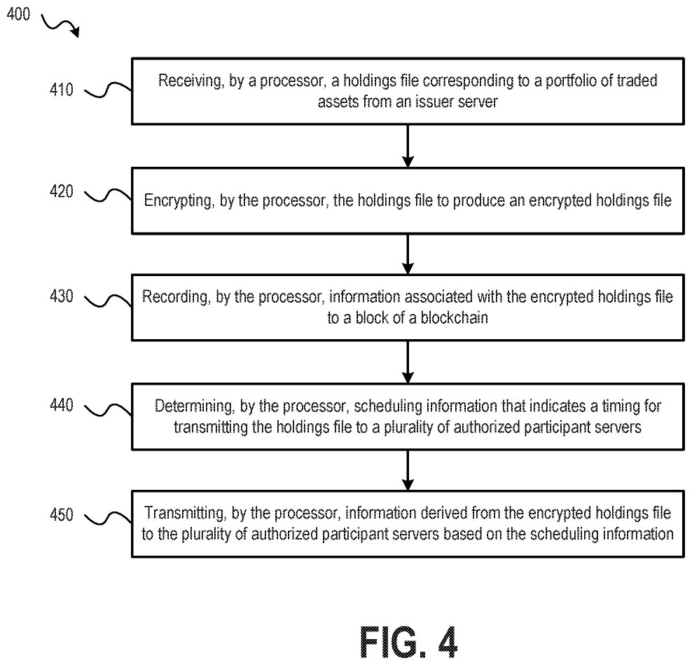

Referring to FIG. 4, a flow diagram of an exemplary method for blockchain-based management a portfolio of traded assets in accordance with embodiments is shown as a method 400. In an embodiment, the method 400 may be performed by the primary authorized participant server 110 of FIG. 1. For example, the steps of the method 400 may be stored as instructions (e.g., the instructions 126 of FIG. 1) that, when executed by one or more processors (e.g., the one or more processors 112 of FIG. 1), cause the one or more processors to perform the steps of the method 400.

At step 410, the method 400 includes receiving a holdings file corresponding to a portfolio of traded assets from an management server. As described above, the holdings file may identify changes to quantities of one or more traded assets held in the portfolio of traded assets. The changes to the quantities of traded assets may be the result of operations of one or more primary authorized participant servers, as described above. At step 420, the method 400 includes encrypting the holdings file to produce an encrypted holdings file. At step 430, the method 400 includes recording information associated with the encrypted holdings file to a block of a blockchain. As described above, recording the information associated with the encrypted holdings file to the block of the blockchain may include determining an address corresponding to a last block of the blockchain and generating the block, which may include information corresponding to the last block of the blockchain, the information associated with the encrypted holdings file, and a timestamp. The information associated with the encrypted holdings file may include at least a portion of the encrypted holdings file. Additionally or alternatively include generating a hash of the holdings file and the information associated with the encrypted holdings file may include the hash of the holdings file. When the hash of the encrypted holdings file is recorded to the blockchain, the encrypted holdings file may be stored in a database.

At step 440, the method 400 includes determining scheduling information that indicates a timing for transmitting the holdings file to a plurality of authorized participant servers. At step 450, the method includes transmitting information derived from the encrypted holdings file to the plurality of authorized participant servers based on the scheduling information. Determining the scheduling information may include calculating a threshold amount of time based on an amount of time associated with processing the holdings file via a plurality of rules engines, where each rules engine of the plurality of rules engines corresponds to one of the plurality authorized participant servers. Additionally, determining the scheduling information may include determining one or more times associated with opening of trading activity at one or more marketplace servers, and the timing indicated by the scheduling information may be configured to initiate transmission of the holdings file to the plurality of authorized participant servers such that each of the plurality of authorized participant servers has sufficient time to process the holdings file prior to an opening of trading activity at the one or more marketplace servers.

In an aspect, the method 400 may include receiving an audit request from a requestor device, as described above, and retrieving information from one or more blocks of the blockchain in response to the audit request. The audit request may identify a time period and the one or more blocks of the blockchain may include information associated with holdings files generated during the time period indicated by the audit request. The method 400 may include generating audit data based on the information retrieved from the one or more blocks of the blockchain and transmitting the audit data to the requestor device. The audit data may include information associated with changes to quantities of the one or more traded assets held in the portfolio during the time period. When the information associated with holdings files includes hash values associated with a plurality of holdings files the method may include retrieving one or more records from a database, where each of the one or more records in the database may include an encrypted holdings file. The method may include decrypting each of the encrypted holdings files, generating a hash value for each of the encrypted holdings files, and comparing the hash values generated for each of the encrypted holdings files to the hash values obtained from the one or more blocks of the blockchain to determine an authenticity of the encrypted holdings files. The audit data may include information that indicates the authenticity of the encrypted holdings files.

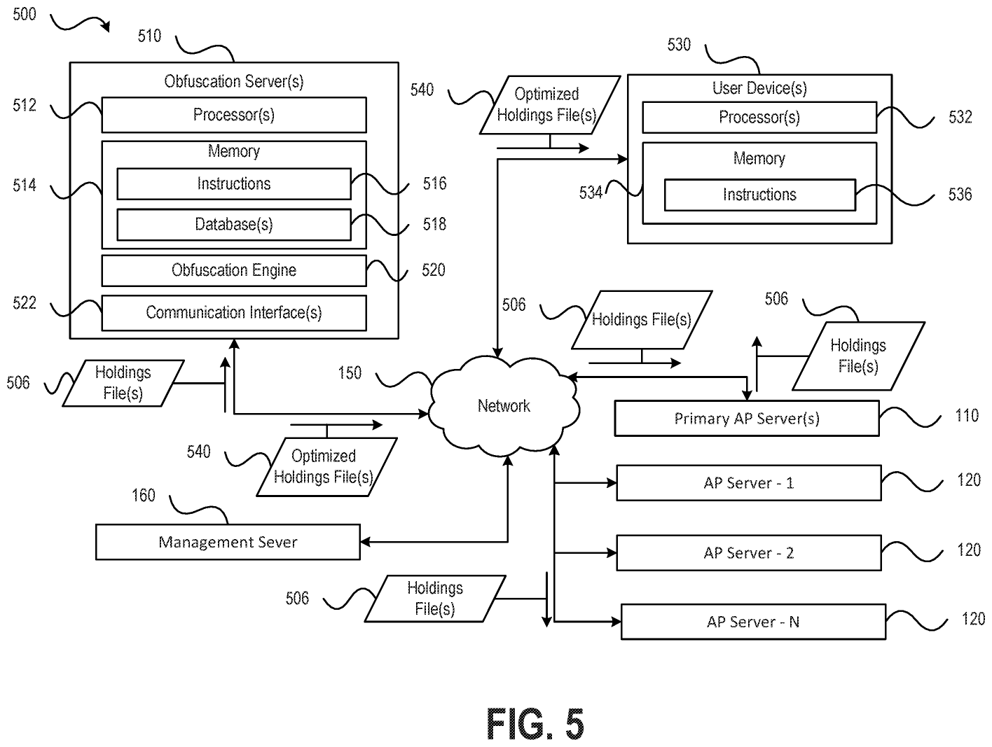

Referring to FIG. 5, a block diagram of an embodiment of a system facilitating secure and transparent distribution of information corresponding to a portfolio of traded assets in accordance with embodiments of the present disclosure is shown as a system 500. As described above, the system 500 may include the primary authorized participant server 110 of FIG. 1, the plurality of authorized participant servers 120 of FIG. 1, the one or more marketplace servers 140 of FIG. 1, and the management server 160 of FIG. 1, each of which may be communicatively coupled to each other via the network 150 and operates in accordance with the features described above with reference to FIGS. 1-4.

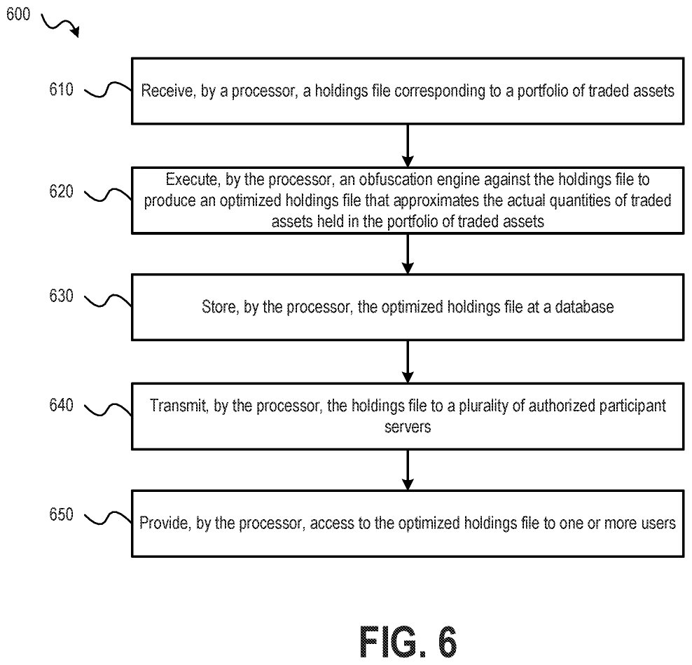

Additionally, the system 500 includes an obfuscation server 510. The obfuscation server 510 may include one or more processors 512, a memory 514, an obfuscation engine 520, and one or more communication interfaces 522 configured to communicatively couple the obfuscation server 510 to one or more external systems (e.g., the primary authorized participant server 110, the management server 160, one or more user device 530, etc.) via the network 150. Each of the one or more processors 512 may be a CPU having one or more processing cores. The memory 514 may include ROM devices, RAM devices, one or more HDDs, one or more flash memory devices, one or more SSDs, one or more NAS devices, other devices configured to store data in a persistent or non-persistent state, or a combination of different memory devices. The memory 514 may store instructions 516 that, when executed by the one or more processors 512, cause the one or more processors 512 to perform operations described in connection with the obfuscation server 510 with reference to FIGS. 5 and 6. Additionally, the memory 514 may be utilized to provide one or more databases 518. Exemplary aspects of the types of information that may be stored in the one or more databases 518 are described in more detail below. The obfuscation server 510 includes an obfuscation engine 520 that is configured to generate optimized holdings files, such as optimized holdings file 540. The optimized holdings files may be generated based on a holdings file 506, which includes information regarding actual quantities of traded assets held in a portfolio of traded assets. Exemplary aspects of generating an optimized holdings file are described in more detail below. The obfuscation server 510 also includes one or more communication interfaces 522 configured to communicatively couple the obfuscation server 510 to the one or more networks 150 via wired or wireless communication links established according to one or more communication protocols (e.g., a institute of electrical and electronics engineers (IEEE) 802.11 protocol, an Ethernet protocol, a 5^{th} Generation (5G) communication standard, and the like).

In addition to generating the optimized holdings files, the obfuscation server 510 may be configured distribute optimized holdings files to one or more users, such as users associated with one or more user devices 530. The one or more user devices 530 may be associated with users of the system 500, such as investors or other persons interested in obtaining public information regarding holdings of a portfolio of traded assets. The information included in the optimized holdings files may be of interest to the one or more users because such information was previous unobtainable or difficult to obtain by the public. One reason why this information may be difficult for the public to obtain is difficulty may be the insider trading regulations imposed by the SEC. Another reason why this information may be unobtainable or difficult to obtain by the public is the desire of providers of portfolios of traded assets to prevent the public from using the information to initiate trades that could negatively impact the portfolio of traded assets. For example, information that identifies the traded assets held in the portfolio of traded assets, if available to the public, could allow the public to implement trading strategies (e.g., front-running and/or free-riding) that could negatively impact the portfolio and its performance (e.g., increasing costs, etc.). From the description above, it is to be appreciated that the information identifying the traded assets held in the portfolio of traded assets is typically protected by entities offering portfolios of traded assets (e.g., an entity offering an ETF, etc.) for a variety of reasons, including regulatory reasons and to prevent misuse of information regarding the portfolio of traded assets.

In the exemplary embodiment of the system 500 shown in FIG. 5, the management server 160 may be operated by an entity that offers a portfolio of traded assets, the primary AP server 110 may periodically receive holdings files 506 regarding the quantities of traded assets held in the portfolio of traded assets, and may distribute the holdings files 506 or portions thereof to the plurality of AP servers 120, as described above with reference to FIG. 1. In an aspect, each of the AP servers participating in the system 500 may be provided with a key that is specific to each AP server (e.g., a first AP server receives a first key specific to the first AP server and a second AP server receives a different key specific to the second AP server). The keys may be distributed by the primary AP server 110. Prior to distributing the encrypted holdings files, the primary AP server 110 may encrypt the holdings file in a format suitable for decryption via the server specific keys provided to each of the AP servers 120. The server specific encrypted holdings files may be received by each of the AP servers 210 and provided to the trading algorithms, which may operate in a secure enclave mode, which allows the trading algorithms to access the server specific key to decrypt the encrypted holdings files to obtain information regarding the holdings of the portfolio of traded assets. Using the decrypted holdings information, the trading algorithms may perform one or more intelligent trading processes designed to achieve the goals of the portfolio of traded assets, as described above with reference to FIGS. 1-4. Because the server specific key may only be accessible to the trading algorithms while operating in a secure enclave mode, the decrypted contents of the holdings file may not be accessible to external systems or server processes (e.g., the operating system, users, etc.). In this manner, the AP entities operating each AP server 120 may only access the encrypted holdings file, but are prevented from accessing the decrypted holdings file or the key that may be used to decrypt the encrypted holdings file. It is noted that although the mechanisms described above for protecting the contents of the encrypted holdings file include a secure enclave processing mode, such description has been provided for purposes of illustration, rather than by way of limitation and that other techniques may be used to prevent malicious (or curious) users from obtaining the contents of the decrypted holdings file in accordance with the concepts disclosed herein.

In addition to distributing the holdings files 506 to the AP servers 120, the primary AP server 110 may transmit the holdings files 506 to the obfuscation server 510. As explained with reference to FIGS. 1-4, the holdings files 506 may identify actual quantities of traded assets held in the portfolio of traded assets, such as to identify a ticker symbol or other information identifying each traded assets held in the portfolio of traded assets and information that indicates a makeup of the portfolio of traded assets. The makeup of the portfolio of traded assets may indicate a percentage or weight for each traded asset held in the portfolio of traded assets, with the percentage or weight indicating an amount of the overall portfolio that is allocated to the particular traded asset associated with the percentage or weight. To illustrate, a portfolio may have a first traded asset identified by ticker symbol “XYZ” and the first traded asset may have an allocation of 1% within the portfolio of traded assets, meaning that the first traded asset accounts for 1% of the traded assets held in the portfolio. The weight or percentage may indicate a per share allocation (e.g., a 1% allocation may indicate the shares of the first traded asset account for 1% of all shares held in the portfolio) or may indicate a monetary allocation (e.g., a 1% allocation may indicate that the value of the shares of the first traded asset can be attributed to 1% of the total value of the traded assets held in the portfolio). Additionally or alternatively, the makeup of the portfolio of traded assets may simply indicate the total number of shares of each traded asset held in the portfolio of traded assets (e.g., 10,000 shares of the traded asset “XYZ”). It is noted that the exemplary techniques for indicating the makeup of the portfolio of traded assets have been provided for purposes of illustration, rather than by way of limitation and that other techniques and methods for indicating the makeup of a portfolio of traded assets may be utilized by the system 500.

The obfuscation server 510, upon receiving the holdings file 506, may execute the obfuscation engine 520 against the holdings file 506 to produce an optimized holdings file 540. The optimized holdings file 540 may be generated such that the optimized holdings file 540 approximates the actual quantities of traded assets held in the portfolio of traded assets, but does not identify the actual quantities of traded assets held in the portfolio of traded assets and in some cases, may not identify all traded assets held in the portfolio. Thus, it may be understood that the term “optimized,” as used with respect to the optimized holdings file, may indicate that the optimized holdings file 540 is different from the actual holdings file with respect to the characterization of a portfolio of traded assets. It is noted that the optimized holdings file 540 may be different from the actual holdings file 506 with respect to the makeup of the portfolio of traded assets, but despite such differences the optimized holdings file may approximate the actual holdings file, as described elsewhere herein.

The set of rules of the obfuscation engine may be configured to modify information included in the holdings file to generate the optimized holdings file 540. The modified information included in the optimized holdings file 540 may be representative of the traded assets held in the portfolio of traded assets while concealing an actual makeup of the traded assets held in the portfolio of traded assets corresponding to the holdings file.

The set of rules may be configured to adjust weights associated with the traded assets held in the portfolio of traded assets to generate the optimized holdings file 540. When adjusting weights, the set of rules of the obfuscation engine 520 may be configured to adjust the weights by a fixed amount. For example, the fixed amount utilized by the set of rules to adjust the weights may be fixed at a 2% adjustment. However, a 2% adjustment is provided by way of illustration and it is to be understood that other adjustment amounts (e.g., 1.5%, 2.2%, 4%, 5%, etc.) may be utilized by embodiments of the present disclosure to modify the holdings file during generation of an optimized holdings file. It is noted that although the adjustment amount may be a fixed amount, the fixed adjustment amount may be applied randomly. To illustrate, suppose the fixed adjustment amount is 1.3% and the holdings file identifies 6 traded assets, including Asset-1, Asset-2, Asset-3, Asset-4, Asset-5, and Asset-6. If Asset-1 makes up 20% of the portfolio of traded assets, Asset-2 makes up 40% of the portfolio of traded assets, Asset-3 makes up 30% of the portfolio of traded assets. Asset-4 makes up 1.3% of the portfolio of traded assets, Asset-5 makes up 3.7% of the portfolio of traded assets, and Asset-6 makes up 5% of the portfolio of traded assets. Randomly applying the 1.3% fixed adjustment amount to the holdings file may include increasing the weights of Assets 1, 3, and 5 by the fixed adjustment amount and reducing the weights of Assets 2, 4, and 6. Such an application of the random fixed adjustment amount may produce an optimized holdings 540 in which Asset-1 makes up 21.3% of the portfolio of traded assets, Asset-2 makes up 38.7% of the portfolio of traded assets, Asset-3 makes up 31.3% of the portfolio of traded assets, Asset-4 makes up 0% of the portfolio of traded assets, Asset-5 makes up 5% of the portfolio of traded assets, and Asset-6 makes up 3.7% of the portfolio of traded assets. As can be appreciated from the foregoing, the total percentage makeup of the holdings file is attributable to all 6 assets, while the total percentage makeup of the optimized holdings file is attributable to only 5 of the 6 assets (e.g., the weight of Asset-4 was reduced from 1.3% to 0%). Such an optimized holdings file 540 approximates the portfolio of traded assets identified in the holdings file 506, but in this specific example does not include all assets held in the portfolio.

It is noted that the randomized adjustment of the weights may adjust weights differently during different executions of the obfuscation engine 520 against the holdings file 506. For example, suppose that the randomized adjustment described above corresponds to an optimized holdings 540 generated during a first period of time (e.g., a Monday) and that a second randomized adjustment is performed during a subsequent period of time (e.g., a Tuesday). The holdings file 506 may identify the same overall makeup of the portfolio of traded assets (e.g., Asset-1 makes up 20% of the portfolio of traded assets, Asset-2 makes up 40% of the portfolio of traded assets, Asset-3 makes up 30% of the portfolio of traded assets, Asset-4 makes up 1.3% of the portfolio of traded assets, Asset-5 makes up 3.7% of the portfolio of traded assets, and Asset-6 makes up 5% of the portfolio of traded assets). However, the random application of the 1.3% fixed adjustment amount to the holdings file may include increasing the weights of Assets 1, 2, and 4 by the fixed adjustment amount (e.g., 1.3%) and reducing the weights of Assets 3, 5, and 6. Such an application of the random fixed adjustment amount may produce an optimized holdings 540 in which Asset-1 makes up 21.3% of the portfolio of traded assets, Asset-2 makes up 41.3% of the portfolio of traded assets, Asset-3 makes up 28.7% of the portfolio of traded assets, Asset-4 makes up 2.6% of the portfolio of traded assets, Asset-5 makes up 2.4% of the portfolio of traded assets, and Asset-6 makes up 3.7% of the portfolio of traded assets. In this second example, the total percentage makeup of the holdings file is attributable to all 6 assets and the total percentage makeup of the optimized holdings file is also attributable to all 6 assets. Such an optimized holdings file 540 approximates the portfolio of traded assets identified in the holdings file 506, but in this specific example does not identify actual weights of all traded assets held in the portfolio of traded assets.

It is to be appreciated that while the two examples above have been described an illustrated using a fixed adjustment weighting factor of 1.3%, the particular fixed adjustment applied during execution of the set of rules against the holdings file may vary randomly. For example, during one execution of the obfuscation engine 520 the fixed amount may be 1.3%, during another execution the fixed amount may be 2.2%, in another execution the fixed amount may be 3%, and so on. In this manner, the optimized holdings file 540 may be prevented from identifying the actual contents of the holdings file 506 and the corresponding actual makeup of the portfolio of traded assets, which may deter use of the optimized holdings file for illicit or detrimental purposes (e.g., insider trading, front-running, free-riding, etc.). Additionally, it is noted that while the examples above illustrate the set of rules of the obfuscation engine 520 as being configured to adjust weights associated with each traded asset, the adjustment of the weights may be applied on a per share basis (e.g., for a traded asset for which 100 shares are identified in the holdings file, a 1.3% increase may be reflected as an optimized holdings file identifying the shares of that traded asset as 101.3 or 101 (if rounded down)), on a per value basis (e.g., if a portfolio holds shares of a traded asset having a value of $100,000, a 2% decrease may reflected as an optimized holdings file identifying the shares of that traded asset having a value of $98,000). It is noted that the exemplary way in which the fixed adjustment may be applied have been provided for purposes of illustration, rather than by way of limitation and that other adjustment techniques and methods may be readily applied by an obfuscation engine 520 according to the present disclosure.

The optimized holdings files generated by the obfuscation engine 520 may be configured to approximate a portfolio structure of the portfolio of traded assets, as described above. Additionally or alternatively, the obfuscation engine 520 may be configured to generate optimized holdings files that approximate a character and risk profile of the portfolio of traded assets. Additionally, the optimized holdings files 540 generated by the set of rules of the obfuscation engine 520 may be configured to satisfy a threshold tracking error. The threshold tracking error may be set to a particular value (e.g., 1%, 2.3%, etc.) and back-testing may be performed to determine an appropriate adjustment threshold for adjusting the portfolio of traded assets such that the optimized portfolio tracks the portfolio of traded assets to within the threshold tracking error. For example, the threshold tracking error may be configured to a value of 1.5%. Back-testing may be performed to identify an adjustment threshold that achieves the 1.5% tracking error. During back-testing, the actual portfolio of traded assets may be adjusted using different adjustment thresholds (e.g., as described above), such as using a first adjustment threshold of 1%, a second adjustment of 1.5%, a third adjustment threshold of 2%, and a fourth adjustment threshold of 3%. Application of the first through fourth adjustment thresholds to the portfolio of traded assets over time may produce a series of optimized portfolios for each adjustment threshold. The series of optimized portfolios for each adjustment threshold may represent a different makeup of the optimized portfolio (e.g., due to the different adjustment thresholds) over a period of time (e.g., a month, a week, three months, six months, and the like).

The values of the optimized portfolios of traded assets and the actual portfolio of traded assets may be calculated over the period of time using historical trading data reflecting the values of the assets held within the portfolio of traded assets and the calculated values may be compared to identify which optimized portfolio falls within the threshold tracking error. For example, suppose the first adjustment threshold produces an optimized portfolio that, over time, has a value that deviates from value of the actual portfolio of traded assets by 1.7%, the second adjustment threshold produces an optimized portfolio that, over time, has a value that deviates from value of the actual portfolio of traded assets by 1.4%, the third adjustment threshold produces an optimized portfolio that, over time, has a value that deviates from value of the actual portfolio of traded assets by 2.3%, and the fourth adjustment threshold produces an optimized portfolio that, over time, has a value that deviates from value of the actual portfolio of traded assets by 1.1%. In such a scenario, the second adjustment threshold may be selected for generating the optimized portfolio of traded assets because the back-testing indicates the second adjustment threshold produces optimized portfolios of traded assets that most closely approximate the 1.5% threshold tracking error. It is noted that in some cases the fourth adjustment threshold may be selected as it is also within the threshold tracking error (e.g., 1.1%). Selecting the fourth adjustment threshold may be beneficial as it may provide more room for deviation-if the error increases by 0.4% the threshold tracking error may still be realized and if the error decreases by up to 1.1%, the optimized portfolio of traded assets will more closely approximate the actual portfolio of traded assets. In an aspect, when two or more adjustment thresholds produce optimized portfolios of traded assets that satisfy the threshold tracking error, but do not directly approximate the threshold tracking error, such as the first adjustment threshold (e.g., providing a 1.7% tracking error) the second adjustment threshold (e.g., providing a 1.4% tracking error), one or more intermediate values for an adjustment threshold may be determined and back-tested to see if any of the intermediate values more closely approximate the threshold tracking error. For example, intermediate values between 1.5% and 2.0% may be determined and used to generate additional optimized portfolios of traded assets that may be subjected to back-testing. If any of the intermediate values provide a tracking error that more closely approximates the threshold tracking error, the intermediate value may be selected for generating optimized portfolios of traded assets, as described above.

As explained above, the holdings file 506 may identify actual quantities of the traded assets held in the portfolio and the optimized holdings file 540 may identify representative quantities of the traded assets held in the portfolio. The representative quantities of traded assets may differ from the actual quantities of the traded assets according to the adjusted weights. In the example above, the adjustment amount was described as a fixed that was applied as either an increase or decrease to the overall weight of each traded asset for purposes of illustration, rather than by way of limitation. In an aspect, the adjustments applied to the weights of the holdings file during generation of the optimized holdings file may be adjusted up to an adjustment threshold, rather than being limited to a static adjustment amount. That is to say, an adjustment threshold may be defined (e.g., 1%, 1.3%, 1.5%, 1.8%, 2%, 2.25%, etc.) and the adjustment threshold may represent a maximum adjustment that may be made to the weights of the holdings file, including a maximum increase and a maximum decrease, but that adjustments less than the adjustment threshold may also be made.

For example, suppose that a holdings file identifies the makeup of the portfolio over six time slots (t, for t=0 to 5) of a time period as shown below in Table 1:

TABLE 1

| Assets | t = 0 | t = 1 | t = 2 | t = 3 | t = 4 | t = 5 |
|---|---|---|---|---|---|---|
| ABC | 20% | 20% | 20% | 20% | 20% | 20% |
| DEF | 30% | 30% | 30% | 30% | 30% | 30% |
| GHI | 25% | 25% | 25% | 25% | 25% | 25% |
| JFK | 25% | 25% | 25% | 25% | 25% | 25% |

Now suppose that the adjustment threshold is configured to a value of 1.5%, meaning that for any particular time slot (t), the adjustment of the weight of an asset in the optimized holdings file must be less than or equal to 1.5% of the actual weight of the asset as indicated in the holdings file. Over the six time slots, optimized holdings files may be generated for each of the holdings files, as shown in Table 2.

TABLE 2

| Assets | t = 0 | t = 1 | t = 2 | t = 3 | t = 4 | t = 5 |
|---|---|---|---|---|---|---|
| ABC | 21.3% | 19.4% | 20 6% | 20.9% | 18.8% | 20% |
| DEF | 28.7% | 30.5% | 30.2% | 30.05% | 30% | 29.9% |
| GHI | 24.3% | 26 5% | 25.1% | 25.3% | 26.1% | 24.3% |
| JFK | 23.5% | 25.7% | 24.8% | 25.9% | 23.9% | 23.7% |

As shown in Table 2, the adjustments applied to the assets in the optimized holdings file were between −1.5% and 1.5% (e.g., within the adjustment threshold). In an aspect, the particular adjustment applied to each asset identified in the optimized holdings file during a particular time slot (t) may be based on a random factor. The factor may be a random number generated between 0 and 100 and may be calculated as:

$${adj}_{i} = \frac{sign ( ) \times {adj}_{threshold} \times ( rand ( ) )}{100} ,$$

where sign( ) is a function configured to generate a positive or negative 1 randomly, adjᵢ is the adjustment factor for an i^{th} traded asset, adj_{threshold} is the adjustment threshold, and rand( ) is a random number generator configured to generate a random number between 0 and 100. To illustrate the equation above using in the example where the adjustment threshold is 1.5%, suppose that the sign( ) function generated a positive 1 and the rand( ) function generated a value of 100. This would yield an adjustment value of +1.5% (e.g., +1.5%=(+1×1.5×100)/100). If the rand( ) function generated a value of 50 and the sign( ) function generated a −1, the adjustment value would be −0.75% (e.g., −0.75° %=(−1×1.5×50)/100). During generation of the optimized holdings file, the equation above may be executed for each asset held in the portfolio such that each asset receives an adjustment between −1.5% and +1.5%.

The optimized holdings file(s) may accurately approximate the actual quantities of traded assets held in the portfolio over time. For example, over a period of time (e.g., a week, a month, a quarter, a year, etc.) the obfuscation server 510 may receive a plurality of holdings files 506 and each holdings file of the plurality of holdings files may correspond to a different point in time (e.g., a time slot) within the period of time. Stated another way, each of the plurality of holdings files may correspond to a particular instance of time or time slot within the time period and may identify the actual makeup of the portfolio of traded assets at the corresponding particular instance of time within the time period. As described above, the obfuscation server 510 may execute the obfuscation engine 520 against each of the holdings files as they are received to generate the plurality of optimized holdings files, each optimized holdings file corresponding to one of the received holdings files and providing an obfuscated view of the makeup of the portfolio of traded assets according to the adjustments made to the information included in the holdings file by the set of rules of the obfuscation engine 520. While each individual optimized holdings file may differ from the corresponding holdings file from which it was generated, in the aggregate, the average characteristics of the plurality of optimized holdings files for the period of time may approximate the average characteristics of the plurality of holdings files for the period of time. Over time, the average adjustment applied to the holdings identified in the holdings files may approach 0% (e.g., because both positive and negative adjustments may be applied during generation of the optimized holdings files).

The obfuscation server 510 may be configured to store the optimized holdings files at a database, such as the database 518. The database 518 may be configured to provide access to the optimized holdings files by the plurality of users, such as the users associated with the user devices 530. It is noted that the users associated with the user devices 530 may be different from the entity that operates the primary AP server 110, the AP servers 120, and the management server 160. Further, although the users accessing the optimized holdings file may be different from these entities, the entities operating the primary AP server 110, the AP servers 120, and the management server 160 may also be able to access the optimized holdings files, such as to verify they are appropriately approximating the actual holdings file and the portfolio of traded assets. As shown in FIG. 5, the user devices 530 may include one or more processors 532 and a memory 534. Each of the one or more processors 532 may be a central processing unit (CPU) having one or more processing cores. The memory 534 may include ROM devices, RAM devices, one or more HDDs, one or more flash memory devices, one or more SSDs, one or more NAS devices, other devices configured to store data in a persistent or non-persistent state, or a combination of different memory devices. The memory 534 may store instructions 536 that, when executed by the one or more processors 532, cause the one or more processors 532 to perform operations described in connection with the user devices 530 with reference to FIGS. 5 and 6. Although not shown in FIG. 5, each of the user devices 530 may include a communication interface configured to communicatively couple the user device to the network 150.

The instructions 536 may be configured to provide a web browser or another application configured to enable the users to access the optimized holdings files. For example, the optimized holdings files 540 stored in the database 518 may be accessible via a web browser or other application. Upon launching the application, the user may request access to the optimized holdings file for a particular day, such as a most recently generated optimized holdings file. Providing the user with access to the optimized holdings file may provide a level of transparency that is currently not provided with many or all types of portfolios of traded assets, such as ETFs and mutual funds. Furthermore, because the optimized holdings file is obfuscated with respect to the actual holdings of the portfolio and only approximates the portfolio, the optimized holdings file may be less likely to be used in problematic ways, such as front-running and free-riding, by the users. In an aspect, the users may access optimized holdings files generated at any time, such as to request an optimized holdings file for a current day, a previous day, a set of optimized holdings files generated for the previous week, etc. In an additional or alternative aspect, the graphical user interface (e.g., the web browser application or standalone application) may be configured to limit access to the most recently generated optimized holdings file. Limiting access to historic optimized holdings files may prevent or mitigate the chances that a user is able to identify the true makeup of the holdings file for the portfolio of traded assets (e.g., by analyzing the average characteristics of the optimized holdings files over time).

In an embodiment, the functionality provided by the obfuscation server 510 may be provided by the primary AP server 110. For example, rather than transmitting the holdings file 506 from the primary AP server 110 to the obfuscation server 510, the primary AP server 110 may be configured to include an obfuscation engine 520 and may generate the optimized holdings file as described above. Such a configuration provides the additional benefit that there is one less entity that knows the true makeup of the portfolio of traded assets. For example, when the optimized holdings file is generated by the obfuscation server 510, the holdings file 506 is provided to both the primary AP server 110 and the obfuscation server 510. If the entity operating the obfuscation server 510 is different from the primary AP server 110, then two entities other than the entity operating the management server 160 will know the actual holdings of the portfolio of traded assets at all times, thereby increasing the possibility that the information included in the holdings file is used for purposes that could be detrimental to the portfolio of traded assets, such as front-running and free-riding. In contrast, where the optimized holdings file is generated by the primary AP server 110 or where the obfuscation server 510 is operated by the same entity that operates the primary AP server 110, fewer entities have access to the holdings file and the likelihood that the holdings file is used improperly may be reduced.

In some embodiments, the optimized holdings file may be generated by the primary AP server 110 and then transmitted to the obfuscation server 510. The obfuscation server 510 may receive the optimized holdings file and operate as a web server to provide network-based access to the optimized holdings files to the user devices 530. It is noted that in the system 500, the primary AP server 110 may also periodically transmit the holdings file 506 to the plurality of AP servers 120, as described above with reference to FIGS. 1-4. Further, in some embodiments, the optimized holdings files 540 or information representative of the optimized holdings files 540 (e.g., a hash of the optimized holdings file) may be recorded to a blockchain, such as the blockchain 119 of FIGS. 1-3. It is noted that the optimized holdings file may not need to be encrypted when recorded to the blockchain (e.g., since the optimized holdings file is intended for public consumption).

Referring to FIG. 6, a flow diagram of an exemplary method for concealing the makeup of a portfolio of traded assets according to embodiments of the present disclosure is shown as a method 600. In an embodiment, the method 600 may be performed by the obfuscation server 510 of FIG. 5. In an additional or alternative embodiment, the method 600 may be performed by the primary authorized participant server 110 of FIGS. 1-3 and 5. The steps of the method 600 may be stored as instructions (e.g., the instructions 516 of FIG. 5 or instructions stored by a memory of the primary AP server 110) that, when executed by one or more processors (e.g., the one or more processors 512 of FIG. 5 or one or more processors of the primary AP server 110), cause the one or more processors to perform the steps of the method 600.

At step 610, the method 600 includes receiving, by a processor, a holdings file corresponding to a portfolio of traded assets. As described above with reference to FIG. 5, the holdings file may identify actual quantities of traded assets held in the portfolio of traded assets. At step 620, the method 600 include executing, by the processor, an obfuscation engine against the holdings file to produce an optimized holdings file that approximates the actual quantities of traded assets held in the portfolio of traded assets. As described above, the obfuscation engine may be the obfuscation engine 520 of FIG. 5 or may be an obfuscation engine incorporated into a primary AP server. The obfuscation engine may include a set of rules configured to modify information included in the holdings file to generate an optimized holdings file that is representative of the traded assets held in the portfolio of traded assets while concealing an actual makeup of the traded assets held in the portfolio of traded assets corresponding to the holdings file. For example, the set of rules may be configured to adjust a makeup of the portfolio of traded assets reflected by the optimized portfolio of traded assets by adjusting weights of the traded, as illustrated in Tables 1-3.

At step 630, the method 600 includes storing, by the processor, the optimized holdings file at a database. The database may be the database 518 of the obfuscation server 510 of FIG. 5. Additionally or alternatively, the optimized holdings file may be stored at a database provided by a blockchain, such as the blockchain 119 of FIGS. 1-3. In yet another aspect, the database may be a database of the primary AP server 110 or a database of a web server. At step 640, the method 600 include transmitting, by the processor, the holdings file to a plurality of AP servers. As described herein, the holdings file may be provided to the plurality of AP (e.g., the AP servers 120 of FIGS. 1-3 and 5) so that the trading algorithms of the AP servers can more efficiently perform market making operations with respect to the portfolio of traded assets. In an embodiment, the holdings files may be encrypted when distributed or transmitted to the plurality of AP servers and decryption of the holdings files may take place within the trading algorithms of each of the AP servers. The encryption and decryption techniques used to secure the holdings file data may be configured to prevent the entities operating the AP servers from retrieving the holdings file data once it is ingested into the trading algorithms. For example, as described above, each AP server participating in the a system operating in accordance with the method 600 may be provided with a key that is specific to each AP server (e.g., a first AP server receives a first key specific to the first AP server and a second AP server receives a different key specific to the second AP server). As the encrypted holdings files are distributed to the AP servers, they may be received by the AP server trading algorithms in encrypted form and the trading algorithms may then apply the server specific key to the encrypted holdings file to obtain information regarding the holdings of the portfolio of traded assets, thereby facilitating intelligent trading processes, as described elsewhere herein. In an aspect, the key may be accessible to the trading algorithms while operating in a secure enclave mode in which operations of the trading algorithms (including decryption of the encrypted holdings file using the server specific key) are performed in a secure environment that is not accessible to external systems or server processes (e.g., the operating system, users, etc.). In this manner, the AP entities operating each AP server may only access the encrypted holdings file, but are prevented from accessing the decrypted holdings file or the key that may be used to decrypt the encrypted holdings file. It is noted that although the mechanisms described above for protecting the contents of the encrypted holdings file include a secure enclave processing mode, such description has been provided for purposes of illustration, rather than by way of limitation and that other techniques may be used to prevent malicious (or curious) users from obtaining the contents of the decrypted holdings file in accordance with the concepts disclosed herein. At step 650, the method 600 includes providing, by the processor, access to the optimized holdings file to one or more users. The one or more users may be different from the entities that operate the plurality of authorized participant servers.

As illustrated and described above with respect to FIGS. 5 and 6, embodiments of the present disclosure enable portfolios of traded assets to be managed more efficiently (e.g., through distribution of holdings files to the plurality of AP servers), while maintaining transparency with respect to public users via distribution of the optimized holdings files. Further, because the optimized holdings files only approximate the actual portfolio of traded assets and conceal or obfuscate the actual holdings of the portfolio of traded assets, the chances that public distribution of the optimized holdings file will enable the users to engage in activities that would negatively impact the portfolio of traded assets (e.g., front-running and free-riding) may be reduced. Accordingly, the system 500 of FIG. 5 and the method 600 of FIG. 6 provide an architecture for facilitating improved distribution of data related to, and management of, a portfolio of traded assets.

Although aspects of the present application and their advantages have been described in detail, it should be understood that various changes, substitutions and alterations can be made herein without departing from the spirit and scope of the embodiments as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the above disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method comprising:
receiving, by a processor, a holdings file corresponding to a portfolio of traded assets, where the holdings file identifies actual quantities of traded assets held in the portfolio of traded assets;
executing, by the processor, an obfuscation engine against the holdings file to produce an optimized holdings file that approximates the actual quantities of traded assets held in the portfolio of traded assets, where the obfuscation engine comprises a set of rules configured to modify information included in the holdings file to generate an optimized holdings file that is representative of the traded assets held in the portfolio of traded assets while concealing an actual makeup of the traded assets held in the portfolio of traded assets corresponding to the holdings file;
storing, by the processor, the optimized holdings file at a database;
transmitting, by the processor, the holdings file to a plurality of authorized participant servers; and
providing, by the processor, access to the optimized holdings file to one or more users, the one or more users being different from the plurality of authorized participant servers.

2. The method of claim 1, where the set of rules are configured to adjust weights associated with the traded assets in the optimized holdings file by a fixed amount.

3. The method of claim 2, where the fixed amount is applied randomly such that a first adjustment of the weights increases the weights for at least some of the traded assets and a second adjustment of the weights decreases the weights for at least some of the traded assets.

4. The method of claim 1, further comprising:
receiving a plurality of holdings file over a period of time, each holdings file of the plurality of holdings files corresponding to a different point in time within the period of time; and
executing the obfuscation engine against each holdings file of the plurality of holdings files to produce a plurality of optimized holdings files over the period of time, where each individual holdings file of the plurality of optimized holdings files corresponds to one holdings file of the plurality of holdings files.

5. The method of claim 4, where average characteristics of the plurality of optimized holdings files approximate average characteristics of the plurality of holdings files over the period of time.

6. The method of claim 5, where characteristics of an individual optimized holdings file of the plurality of optimized holdings files do not approximate characteristics of a holdings file corresponding to the individual optimized holdings file during a period of time associated with the individual holdings file and the corresponding holdings file.

7. The method of claim 1, where the optimized holdings file approximates a portfolio structure of the portfolio of traded assets, a character and risk profile of the portfolio of traded assets, or both.

8. The method of claim 1, where the holdings file identifies actual quantities of the traded assets held in the portfolio and the optimized holdings file identifies representative quantities of the traded assets held in the portfolio, the representative quantities of the traded assets differing from the actual quantities of the traded assets according to the adjusted weights.

9. The method of claim 1, where the set of rules are configured to produce optimized holdings files that satisfy a threshold tracking error.

10. The method of claim 1, where the holdings file identifies a first traded asset and the optimized holdings file does not identify the first traded asset as being held in the portfolio.

11. A non-transitory computer-readable storage medium storing instructions that, when executed by one or more processors, cause the one or more processors to perform operations comprising:
receiving a holdings file corresponding to a portfolio of traded assets, where the holdings file identifies actual quantities of traded assets held in the portfolio of traded assets;
executing an obfuscation engine against the holdings file to produce an optimized holdings file that approximates the actual quantities of traded assets held in the portfolio of traded assets, where the obfuscation engine comprises a set of rules configured to modify information included in the holdings file to generate an optimized holdings file that is representative of the traded assets held in the portfolio of traded assets while concealing an actual makeup of the traded assets held in the portfolio of traded assets corresponding to the holdings file;
storing the optimized holdings file at a database;
transmitting the holdings file to a plurality of authorized participant servers; and
providing access to the optimized holdings file to one or more users, the one or more users being different from the plurality of authorized participant servers.

12. The non-transitory computer-readable storage medium of claim 11, where the set of rules are configured to adjust weights associated with the traded assets in the optimized holdings file by a fixed amount.

13. The non-transitory computer-readable storage medium of claim 12, where the fixed amount is applied randomly such that a first adjustment of the weights increases the weights for at least some of the traded assets and a second adjustment of the weights decreases the weights for at least some of the traded assets.

14. The non-transitory computer-readable storage medium of claim 11, the operations further comprising:
receiving a plurality of holdings file over a period of time, each holdings file of the plurality of holdings files corresponding to a different point in time within the period of time; and
executing the obfuscation engine against each holdings file of the plurality of holdings files to produce a plurality of optimized holdings files over the period of time, where each individual holdings file of the plurality of optimized holdings files corresponds to one holdings file of the plurality of holdings files.

15. The non-transitory computer-readable storage medium of claim 14, where average characteristics of the plurality of optimized holdings files approximate average characteristics of the plurality of holdings files over the period of time, and where characteristics of an individual optimized holdings file of the plurality of optimized holdings files do not approximate characteristics of a holdings file corresponding to the individual optimized holdings file during a period of time associated with the individual holdings file and the corresponding holdings file.

16. The non-transitory computer-readable storage medium of claim 11, where the optimized holdings file approximates a portfolio structure of the portfolio of traded assets, a character and risk profile of the portfolio of traded assets, or both, and where the set of rules are configured to produce optimized holdings files that satisfy a threshold tracking error.

17. The non-transitory computer-readable storage medium of claim 11, where the holdings file identifies actual quantities of the traded assets held in the portfolio and the optimized holdings file identifies representative quantities of the traded assets held in the portfolio, the representative quantities of the traded assets differing from the actual quantities of the traded assets according to the adjusted weights.

18. The non-transitory computer-readable storage medium of claim 1, where the optimized holdings file is not provided to the plurality of authorized participant servers.

19. A system comprising:
one or more processors configured to:
receive a holdings file corresponding to a portfolio of traded assets, where the holdings file identifies actual quantities of traded assets held in the portfolio of traded assets;
execute an obfuscation engine against the holdings file to produce an optimized holdings file that approximates the actual quantities of traded assets held in the portfolio of traded assets, where the obfuscation engine comprises a set of rules configured to modify information included in the holdings file to generate an optimized holdings file that is representative of the traded assets held in the portfolio of traded assets while concealing an actual makeup of the traded assets held in the portfolio of traded assets corresponding to the holdings file;
store the optimized holdings file at a database; and
provide access to the optimized holdings file to one or more users, the one or more users being different from the plurality of authorized participant servers; and
a memory configured to store the database.

20. The system of claim 19, wherein the one or more processors are configured to:
generate the holdings file;
encrypt the holdings file;
record the encrypted holdings file or information derived from the encrypted holdings file to a blockchain; and
transmit the encrypted holdings file to a plurality of authorized participant servers.
